(19) United States
(12) Patent Application Publication
(10) Pub. No.: US 2026/0209036 A1
(43) Pub. Date: Jul. 23, 2026

(54) BIOCIDE FORMULATIONS FOR CONTROL OF HYDROGEN-CONSUMING MICROORGANISMS

(71) Applicant: Energy Solutions (US) LLC, The Woodlands, TX (US)

(72) Inventors: Renato De Paula, The Woodlands, TX (US); Chris Jones, Wallsall (GB)

(73) Assignee: Energy Solutions (US) LLC, The Woodlands, TX (US)

(21) Appl. No.: 19/452,712

(22) Filed: Jan. 19, 2026

Related U.S. Application Data
(60) Provisional application No. 63/746,428, filed on Jan. 17, 2025.

(51) Int. Cl. C01B 3/001; A01N 25/10; A01N 57/20; A01P 1/00

(52) U.S. Cl. CPC C01B 3/001; A01N 25/10; A01N 57/20; A01P 1/00

(57) ABSTRACT

Provided is a method of inhibiting hydrogen gas metabolism, the method including the steps of introducing an inhibitor composition into a vessel configured to store hydrogen gas, wherein the inhibitor composition includes a tetrakis hydroxymethyl phosphonium salt and water. Also provided is a method of treating a hydrogen gas storage system with the inhibitor composition and the use of the inhibitor composition for inhibiting the metabolism of hydrogen gas in a storage system by microorganisms.

### BACKGROUND

Hydrogen gas is growing in importance as a green fuel alternative. Despite its potential advantages, storage of the fuel presents unique long-term challenges. Storage considerations include adequate available volume and sanitary or chemically inert conditions. Of interest are subterranean formations such as depleted oil reservoirs and salt caverns. While oil reservoirs and salt caverns offer significant available volume for storing hydrogen gas, the conditions inside these formations are not generally sanitary or chemically inert. The formations include, among other things, microorganisms which may use hydrogen gas as an electron donor in the conversion of sulfates into hydrogen sulfide and acetate into methane. This presents a long-term problem by converting valuable hydrogen gas into an undesirable and toxic byproduct.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of inhibiting hydrogen gas metabolism, the method comprising the steps of introducing an inhibitor composition into a vessel configured to store hydrogen gas, wherein the inhibitor composition comprises a tetrakis hydroxymethyl phosphonium salt, and water.

In another aspect, embodiments disclosed herein relate to a method of treating a hydrogen gas storage system, the method comprising the steps of introducing an inhibitor composition into a system, wherein the inhibitor composition comprises a tetrakis hydroxymethyl phosphonium salt, and water.

In another aspect, embodiments disclosed herein relate to the use of an inhibitor composition comprising a tetrakis hydroxymethyl phosphonium salt and water to inhibit the metabolism of hydrogen gas in a storage system by microorganisms

Other aspects and advantages of the claimed subject matter will be apparent from the following description and the appended claims.

### BRIEF DESCRIPTION OF DRAWINGS

FIG. 1 shows hydrogen consumption (A) and changes in medium pH (B) in Methanogenic culture treated with THPS.

FIG. 2 shows hydrogen consumption (A) and changes in medium pH (B) in Sulfidogenic culture treated with THPS.

FIG. 3 shows hydrogen consumption (A) and changes in medium pH (B) in Methanogenic culture treated with THPS+polymer.

FIG. 4 shows hydrogen consumption (A) and changes in medium pH (B) in Sulfidogenic culture treated with THPS+polymer.

FIG. 5 shows corrosion rate on carbon steel ball bearings exposed to culture of Desulfohalobium retbaense cells cultivated in the presence of hydrogen and treated with different concentrations of THPS+polymer.

### DETAILED DESCRIPTION

Embodiments disclosed herein generally relate to the inhibition of hydrogen gas metabolism by active microorganisms using biocidal inhibitor compositions. Advantageously inhibitor compositions described herein may also have the benefit of acting as corrosion inhibitors when used in systems containing hydrogen gas. Without being bound by theory, inhibitor compositions according to the present disclosure exhibit unique modes of action that prevent bacteria from utilizing hydrogen, even at sub-biocidal concentrations. This protects stored hydrogen fuel from bacterial consumption and also prevents microbial induced corrosion by controlling the cathodic depolarization associated with hydrogen removal from a corrosion site.

### Biocidal Inhibitor Composition

In one or more embodiments, inhibitor compositions according to the present disclosure comprise a tetrakis hydroxymethyl phosphonium (THP) salt, and optionally water. The water may be brine, seawater, or combinations thereof. While the inhibitor compositions may be provided as a solution, the compositions may also be supplied as a solid, for example a solid formed by coating the components onto, or absorbing the components into, a powdery granular or porous acid substrate such as a carboxylic acid substrate, such as for example adipic acid, benzoic acid, or salts thereof, or by incorporation into a waxy substrate.

In embodiments, the tetrakis hydroxymethyl phosphonium salt has a formula of THP-X, where X is selected from chloride, sulphate, bromide, iodide, phosphate, phosphite, acetate, oxalate, citrate, borate, silicate, chlorate, lactate, nitrate, fluoride, carbonate, formate, and combinations thereof. The tetrakis hydroxymethyl phosphonium salt may be for example tetrakis hydroxymethyl phosphonium sulfate (THPS). The THP salt may be present in an amount ranging from 10 to 80 wt %, relative to the total weight of the inhibitor composition, for example from a lower limit of any of 5, 10, 20, or 30 wt % to an upper limit of any of 60, 70, or 80 wt %, where any lower limit can be used in combination with any suitable upper limit.

In one or more embodiments, inhibitor compositions further comprise a polymer. The polymer may be a biopenetrating polymer, or biopenetrant. The biopenetrant may be a phosphonate end-capped biopenetrant which comprises a polymer of an unsaturated carboxylic acid or a copolymer of an unsaturated carboxylic acid with a sulphonic acid, said polymer or copolymer being terminated by a mono- or diphosphonated unsaturated carboxylic acid group or having such monomers incorporated into the polymer backbone. In embodiments, the polymer may be end-capped with a phosphorous acid group. The biopenetrant polymer may be a polyacrylate terminated with vinylphosphonic acid (VPA) or with vinylidene-1,1-diphosphonic acid (VDPA), or a polyacrylate incorporating VPA and/or VDPA monomers, or an acrylate/sulphonate copolymer (i.e. a copolymer of acrylic acid and unsaturated sulphonic acid monomers) terminated with vinylidene-1,1-diphosphonic acid or with vinylphosphonic acid, or an acrylate/sulphonate copolymer incorporating VPA and/or VDPA monomers. The polymer may be a combination of polymers and/or biopenetrants. The polymer may be present in an amount ranging from 0.05 to 25 wt %, relative to the total weight of the inhibitor composition, for example from a lower limit of any of 0.05, 0.1, 0.5, 1, 5, or 10 wt % to an upper limit of any of 10, 15, 20, or 25 wt %, where any lower limit can be used in combination with any suitable upper limit. In one or more embodiments, the ratio of VPA or VDPA end-capped polymer or copolymer to THP salt, is, when expressed as a percentage by weight, in the range of from 0.5 to 50%.

Inhibitor compositions according to some embodiments may comprise additives. Additives may be, for example, corrosion inhibitors such as primary, secondary or tertiary alcohols having an acetylenic bond in the carbon backbone, octyl phosphonic acid (OPA) and thioglycolic acid; control agents for bacteria or other microbes such as nitrates, nitrites and anthraquinone, and combinations thereof. The additives may be present in an amount ranging from 0.01 to 25 wt %, relative to the total weight of the inhibitor composition, for example from a lower limit of any of 0.01, 0.05, 0.1, 0.5, 1, 5, or 10 wt % to an upper limit of any of 10, 15, 20, or 25 wt %, where any lower limit can be used in combination with any suitable upper limit.

According to one or more embodiments, inhibitor compositions are configured to inhibit or disrupt the metabolic activity of active microbes. The active microbes may be, for example, sulphate-reducing prokaryotes, sulphate-reducing bacteria, sulphate-reducing archaea, and methanogenic archaea. These microbes may perform a range of undesirable activities, including but not limited to generating hydrogen sulphide, generating methane, and inducing corrosion.

### Method of Inhibiting Hydrogen Gas Metabolism

In one or more embodiments, a method of inhibiting the metabolism or consumption of hydrogen gas, for example by microbial action, comprises treatment, generally of an aqueous fluid, by introducing an inhibitor composition according to one or more embodiments disclosed herein into a vessel configured to store hydrogen gas, a process or apparatus where hydrogen gas is present, or an area where hydrogen gas is present. The inhibitor composition may be introduced in a batch process, continuous process, or any combination thereof. Introduction by batch process comprises the addition of an amount of inhibitor composition in one instance or in multiple instances. Introduction by continuous process comprises the addition of inhibitor composition by feeding over a period time.

The THP salt may be present in an amount ranging from 1 to 30 ppm, relative to the total weight of the treated aqueous fluid, for example from a lower limit of any of 1, 2, 3, 4, 5, 6, 7, 8, 9, or 10 ppm to an upper limit of any of 10, 15, 20, 25, or 30 ppm, where any lower limit can be used in combination with any suitable upper limit.

### System for Hydrogen Gas Storage

In one or more embodiments, a system for storing hydrogen gas comprises a vessel configured to store hydrogen gas, an aqueous fluid, a hydrogen gas inlet fluidly connected to the vessel, an aqueous fluid inlet fluidly connected to the vessel, a hydrogen gas outlet fluidly connected to the vessel, an aqueous fluid outlet fluidly connected to the vessel. In certain embodiments, either or both of the hydrogen gas inlet or the aqueous fluid inlet may function as both an inlet and an outlet.

In one or more embodiments, the vessel configured to store hydrogen gas may be a depleted oil reservoir, salt cavern, or a container for storing or processing hydrogen gas. Depleted oil reservoirs may contain hydrocarbons; it is therefore envisioned that the inhibitor compositions function both in the presence of and in the absence of hydrocarbons.

### Method of Treating a Hydrogen Gas Storage System

In one or more embodiments, a method of treating a hydrogen gas storage system includes introducing an inhibitor composition according to one or more embodiments disclosed herein into a system for storage of hydrogen gas. The inhibitor composition may be introduced in a batch process, continuous process, or any combination thereof. Introduction by batch process comprises the addition of an amount of inhibitor composition in one instance or in multiple instances. Introduction by continuous process comprises the addition of inhibitor composition by feeding over a period time.

The THP salt may be present in an amount ranging from 1 to 30 ppm, relative to the total weight of the treated aqueous fluid, for example from a lower limit of any of 1, 2, 3, 4, 5, 6, 7, 8, 9, or 10 ppm to an upper limit of any of 10, 15, 20, 25, or 30 ppm, where any lower limit can be used in combination with any suitable upper limit.

### Method of Inhibiting Corrosion

In one or more embodiments, inhibitor compositions according to one or more embodiments disclosed herein may be used to reduce or prevent the corrosion of metal surfaces used, for example in hydrogen storage systems, such as steel, by microbes.

### Examples

### Preparation of Inhibitor Compositions

Inhibitor compositions were prepared fresh according to Table 1 by diluting the active molecule(s) in a sterile dilute sodium bicarbonate solution which was made anaerobic.

TABLE 1

| Inhibitor | | Concentration of | |
|---|---|---|---|
| Composition | Active molecule | active molecule | Stock solution |
| 3 | THPS | 75% | 5000 ppm |
| 4 | THPS + Polymer | 50-60% | 5000 ppm |

### Hydrogen Gas Consumption Testing

The consumption rate of H₂-consuming sulfate-reducing bacteria (SRB) and a methanogen (M) was tested to evaluate the effect of inhibitor compositions on active microbes.

Incubation media were prepared anaerobically under sterile conditions according to Table 2 following standard DSMZ protocols unless otherwise noted. Specifically, ammonium chloride, resazurin, cysteine, yeast extract, and trypticase peptone were omitted from the incubation media.

TABLE 2

| | 905: | |
|---|---|---|
| | Methanoclaculus | 499: |
| | Halotolerans | Desulfohalobium |
| | Medium | Medium |
| K₂HPO₄ (g) | 0.30 | 0.30 |
| KH₂PO₄ (g) | 0.30 | 0.30 |
| MgCl × 6 H₂O (g) | 3.20 | 20.00 |
| NaCl (g) | 50.00 | 100.00 |
| CaCl₂ × 2 H₂O (g) | 0.60 | 2.70 |
| KCl (g) | 0.17 | 4.00 |
| Na₂SO₄ (g) | | 3.00 |
| Na-Acetate (g) | 0.50 | 1.00 |
| Modified Wolin's mineral soln | 10.00 | |
| (mL) | | |
| NaHCO₃ (g) | 2.00 | |
| Na-(L)-Lactate (g) | | 2.50 |
| Trace element soln. SL-10 (mL) | | 1.00 |
| Selenite-tungstate soln (mL) | | 1.00 |
| Na₂S × 9 H₂O (g) | 0.30 | 0.30 |
| Distilled Water (mL) | 1000.00 | 1000.00 |

Precultures of Desulfohalobium (SRB) and Methanocalculus (methanogen) were grown under ideal state conditions including all supplementary carbon sources (i.e., yeast extract, lactate, peptone), specifically:
SRB: 20 mM lactate, 1 mM acetate (if not already in the medium), 1 drop of yeast extract, N₂—CO₂ headspace-Growth time: ~1 week at 37° C.
Methanogen: 1 drop of yeast extract, 1 mM acetate (if not already in the medium), H₂—CO₂ headspace-Growth time: ~1 week at 37° C.

Prior to H₂ consumption testing, 1 drop of 1 M sodium nitrate was added to the culture media.

Abiotic controls were performed with no addition of preculture media. Biological controls were performed with no addition of inhibitor composition.

Incubation samples were prepared in 50 mL serum bottles according to Table 3.

TABLE 3

| | | | |
|---|---|---|---|
| Incubation Total Volume | ~25 | mL | |
| Culture Volume | 1 | mL | |
| Medium Volume | 22-24 | mL | dependent on inhibitor |
| | | | composition dosage |

| | | |
|---|---|---|
| Headspace | 100% H2 | sulfate-reducing bacteria |
| | | (SRB) |
| | 90-10 H2—CO2 | methanogen (M) |

Incubation samples were prepared for inhibitor composition dosages of 0, 10, 25, 50, 100, 250, and 500 ppm added from the inhibitor composition stock solutions according to Table 1.

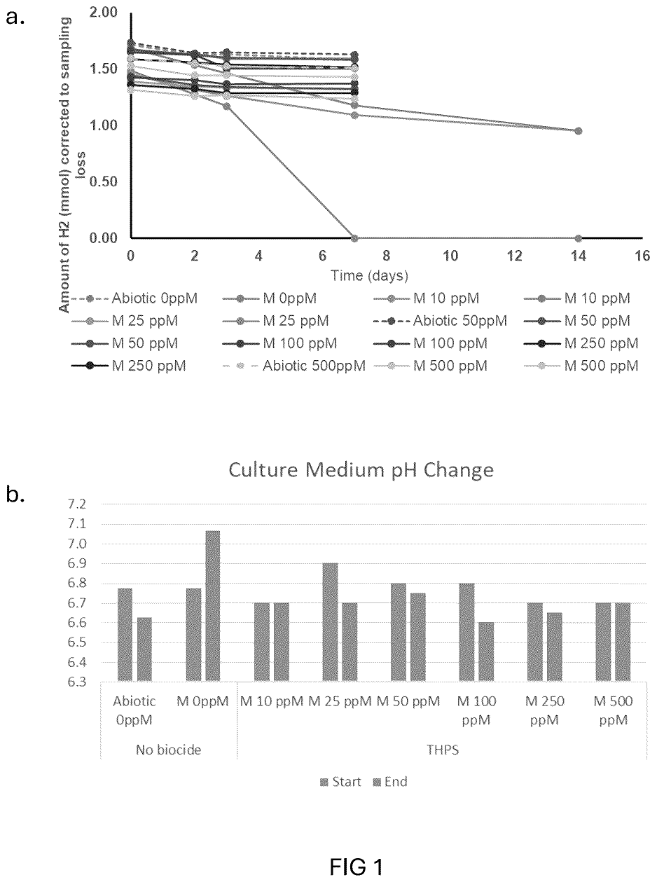

Inhibitor compositions were added to the medium 1 hour prior to injection of pre-culture to allow the pH to stabilize within the microbe growth range. After the pH check, 1 mL of pre-culture was added to the testing bottles. The headspace was flushed with appropriate gas mix for 1 min and set to an over pressure of ~750 mbar. Samples were incubated at 37° C. Pressure and headspace analysis by gas chromatography were monitored once per week for SRB and every 2-3 days for M during the incubation period. Increase in pH of the cultures is used as an indirect indication of hydrogen consumption. The pH of the medium was measured at the beginning and after the incubation period. Results of the hydrogen consumption and pH testing are presented in FIGS. 1-4.

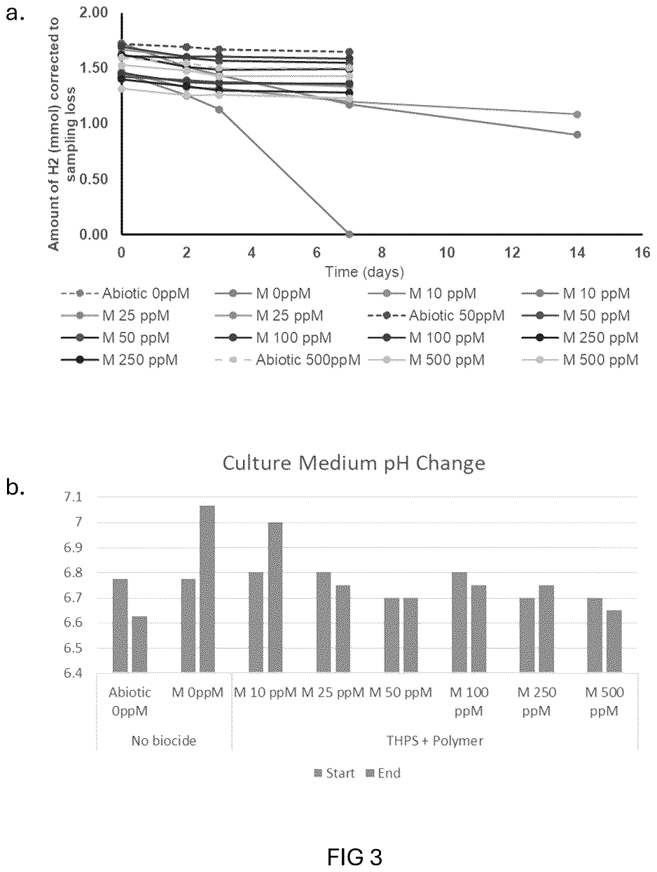

Referring to FIGS. 1 and 3, the data show essentially complete consumption of H₂ gas by the methanogen after 7 days of incubation. Samples comprising at least 10 ppm inhibitor composition exhibit significantly reduced H₂ gas consumption, with samples comprising at least 25 ppm inhibitor composition exhibiting no significant consumption of H₂ gas over the measured time period.

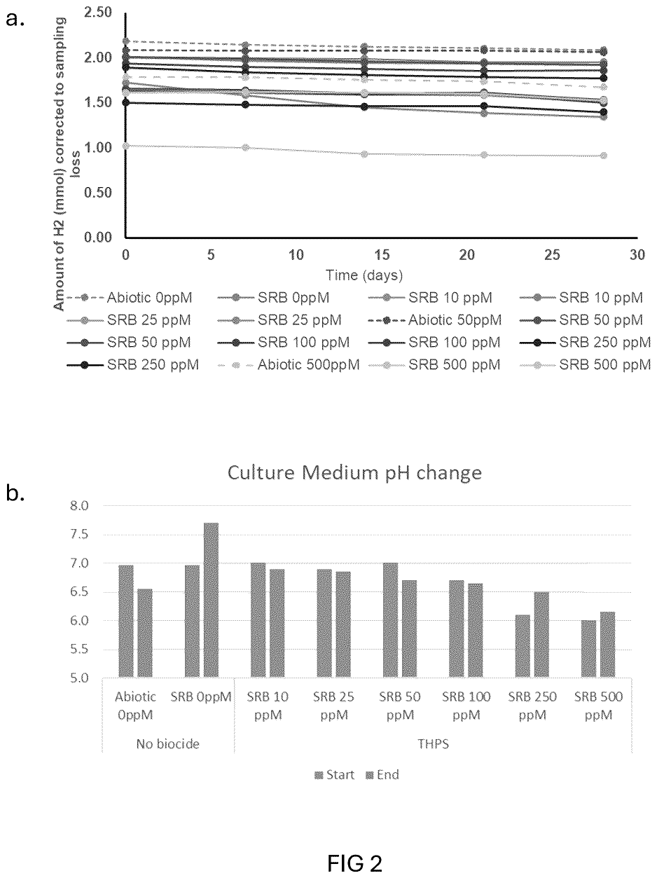

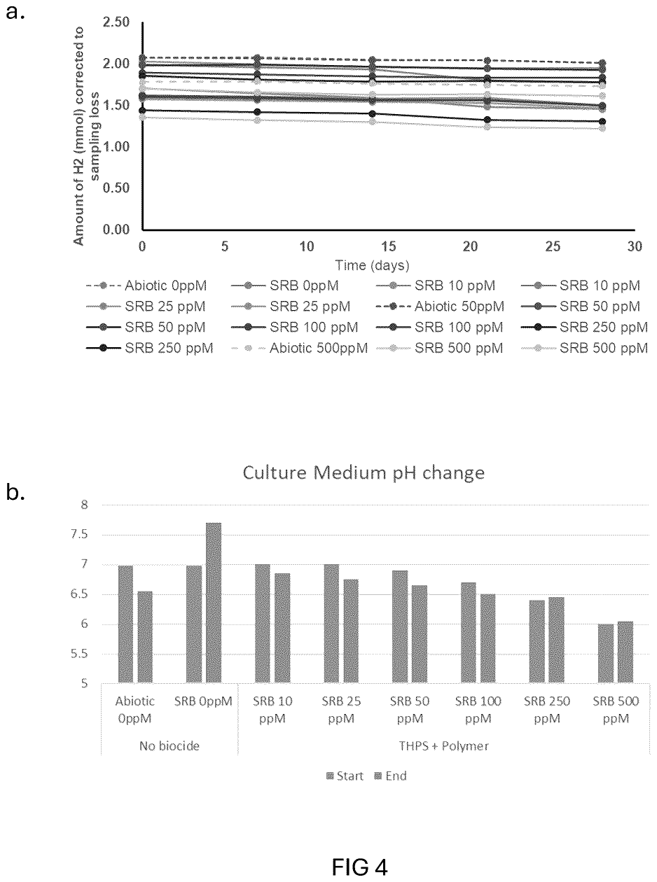

Referring to FIGS. 2 and 4, the sulfate-reducing bacteria consume H₂ gas from a corrected amount of H₂ of ~1.75 to ~1.50 or less over the measured time period. Samples comprising at least 10 ppm inhibitor composition exhibit no significant consumption of H₂ gas over the measured time period.

### Corrosion Testing

Corrosion of iron beads (diameter: 0.45 cm) was assessed using incubation media prepared according to the above protocols for H₂ gas consumption testing. Prior to testing, sterile beads were treated according to the modified NACE SP0775-2013 protocol described in Pinnock, T., Voordouw, J. & Voordouw, G. Use of carbon steel ball bearings to determine the effect of biocides and corrosion inhibitors on microbiologically influenced corrosion under flow conditions. Appl Microbiol Biotechnol 102, 5741-5751 (2018) (https://doi.org/10.1007/s00253-018-8974-9). The incubation media were prepared according to Table 3 and three iron beads were placed in each sample. Incubation samples were prepared for inhibitor composition dosages of 0, 10, 50, and 500 ppm added from the inhibitor composition stock solutions according to incubator composition 4 in Table 1. Samples were incubated at 37° C. for 25 days for SRB and 27 days for M. After measuring the headspace and pH, the beads were removed from the experimental bottle and cleaned using the NACE SP0775-2013 protocol. Weight of the beads was recorded and corrosion rate is calculated as:

$$CR = 87 , 600 \times Δ W / ( D \times A \times T )$$

where W is the change in mass of the beads, D is the density, A is the exposed area, and T is the time. Density of the beads was taken as 7.85 g/cm³ for carbon steel.

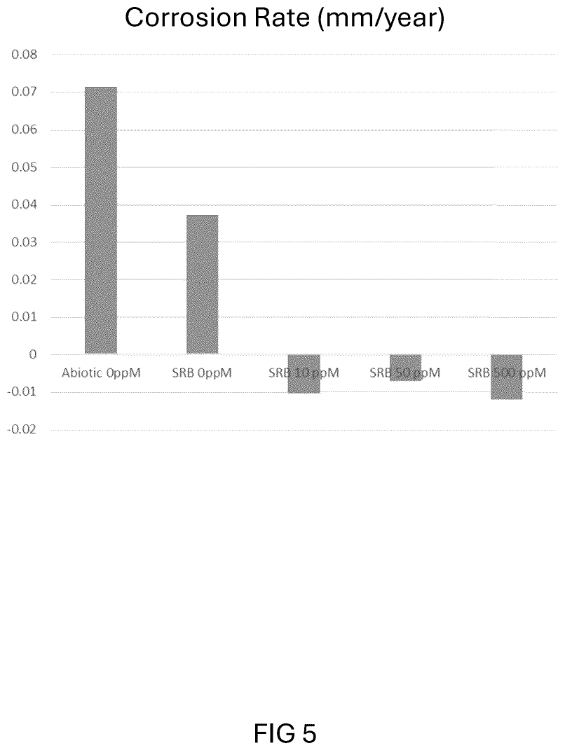

The corrosion rate (mm/yr) of the beads is provided in FIG. 5. The data show that addition of at least 10 ppm of the inhibitor composition substantially inhibits corrosion of the beads over the measured time period.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112(f) for any limitations of any of the claims herein, except for those in which the claim expressly uses the words ‘means for’ together with an associated function.

1. A method of inhibiting hydrogen gas metabolism, the method comprising the steps of:
introducing an inhibitor composition into a vessel configured to store hydrogen gas,
wherein the inhibitor composition comprises:
a tetrakis hydroxymethyl phosphonium salt, and
water.

2. The method according to claim 1, wherein the composition further comprises a polymer.

3. The method according to claim 2, wherein the polymer is a biopenetrant and the biopenetrant is selected from phosphonate endcapped biopenetrants which comprises a polymer of an unsaturated carboxylic acid or a copolymer of an unsaturated carboxylic acid with a sulphonic acid, said polymer or copolymer being terminated by a mono- or diphosphonated unsaturated carboxylic acid group or having such monomers incorporated into the polymer backbone.

4. The method according to claim 2, wherein the polymer is selected from a polyacrylate incorporating VPA and/or VDPA monomers; an acrylate/sulphonate copolymer terminated with vinylidene-1,1-diphosphonic acid or with vinylphosphonic acid; an acrylate/sulphonate copolymer incorporating VPA and/or VDPA monomers; or a polymer terminated with at least one phosphorous acid group.

5. The method according to claim 2, wherein the polymer is in an amount of from 0.05 to 25 wt %, based on the total weight of the composition.

6. The method according to claim 1, wherein the tetrakis hydroxymethyl phosphonium salt has a formula THP-X, where X is selected from chloride, sulphate, bromide, iodide, phosphate, phosphite, acetate, oxalate, citrate, borate, silicate, chlorate, lactate, nitrate, fluoride, carbonate, formate, and combinations thereof.

7. The method according to claim 1, wherein the tetrakis hydroxymethyl phosphonium salt is tetrakis hydroxymethyl phosphonium sulfate (THPS) and/or tetrakis hydroxymethyl phosphonium chloride (THPC).

8. The method according to claim 1, wherein the composition is configured to inhibit or disrupt the metabolic activity of active microbes.

9. The method according to claim 8, wherein the active microbes are selected from sulphate-reducing prokaryotes, sulphate-reducing bacteria, sulphate-reducing archaea, and methanogenic archaea.

10. The method according to claim 8, wherein the metabolic activity of sulphate-reducing prokaryotes is selected from the generation of hydrogen sulphide, the generation of methane, and microbially-induced corrosion.

11. A method of treating a hydrogen gas storage system, the method comprising the steps of:
introducing an inhibitor composition into a system,
wherein the inhibitor composition comprises:
a tetrakis hydroxymethyl phosphonium salt, and
water.

12. The method according to claim 11, wherein the composition further comprises a polymer.

13. The method according to claim 12, wherein the polymer is a biopenetrant and the biopenetrant is selected from phosphonate endcapped biopenetrants which comprises a polymer of an unsaturated carboxylic acid or a copolymer of an unsaturated carboxylic acid with a sulphonic acid, said polymer or copolymer being terminated by a mono- or diphosphonated unsaturated carboxylic acid group or having such monomers incorporated into the polymer backbone.

14. The method according to claim 12, wherein the polymer is selected from a polyacrylate incorporating VPA and/or VDPA monomers; an acrylate/sulphonate copolymer terminated with vinylidene-1,1-diphosphonic acid or with vinylphosphonic acid; an acrylate/sulphonate copolymer incorporating VPA and/or VDPA monomers; or a polymer terminated with at least one phosphorous acid group.

15. The method according to claim 12, wherein the polymer is in an amount of from 0.05 to 25 wt %, based on the total weight of the composition.

16. The method according to claim 12, wherein the tetrakis hydroxymethyl phosphonium salt has a formula THP-X, where X is selected from chloride, sulphate, bromide, iodide, phosphate, phosphite, acetate, oxalate, citrate, borate, silicate, chlorate, lactate, nitrate, fluoride, carbonate, formate, and combinations thereof.

17. The method according to claim 12, wherein the tetrakis hydroxymethyl phosphonium salt is tetrakis hydroxymethyl phosphonium sulfate (THPS) and/or tetrakis hydroxymethyl phosphonium chloride (THPC).

18. The method according to claim 12, wherein the composition is configured to inhibit or disrupt the metabolic activity of active microbes selected from sulphate-reducing prokaryotes, sulphate-reducing bacteria, sulphate-reducing archaea, or methanogenic archaea.

19. The method according to claim 18, wherein the metabolic activity of sulphate-reducing prokaryotes is selected from the generation of hydrogen sulphide, the generation of methane, and microbially-induced corrosion.

20. The method according to claim 11, wherein the inhibitor composition is added in an amount of from 1 to 30 ppm, based on the total volume of aqueous fluid present in the system.
